(19) United States
(12) Patent Application Publication
(10) Pub. No.: US 2002/0108284 A1
(43) Pub. Date: Aug. 15, 2002

(54) Identification tag

(76) Inventor: Valerie J. Wallin, Kentwood, MI (US)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 09/780,777

(22) Filed: Feb. 9, 2001

(51) Int. Cl. G09F 21/02

(52) U.S. Cl. 40/586

(57) ABSTRACT

An identification tag includes a holder having a pair of rigid, transparent polymeric panels joined at a lower region by a flexible resilient hinge. The top edge of the rear panel is configured to abuttingly contact the front panel to thereby securely hold an indicia-carrying panel therebetween. Preferably, the front panel and rear panel are of differing height, while the front panel is configured to carry a neckband to enable the identification tag to be worn about the neck of a person. The front panel, rear panel, and hinge are preferably monolithically formed to thereby provide a low-cost, durable, and reusable identification tag.

### BACKGROUND OF THE INVENTION

The present invention relates generally to identification tags and, more particularly, to a reusable, identification tag worn by individuals.

Identification or name tags are conventionally worn by individuals in a variety of both business and social engagements in order to identify a person by name. In addition, identification tags are used to identify the person as belonging to, or employed by, a particular organization; such as, for instance, trade shows and conventions, seminars, hospitals, industrial facilities, educational institutions, and the like.

Conventionally, these tags are worn by the individual and include a thin, flexible piece of plastic having at least two sides that are either sealed along three sides to form a pocket, or are bent in a flattened tube that opens to the lateral sides in a direction to form a pair of guideways which capture an indicia-carrying panel. The tag is attached to an article of clothing by a variety of attachment assemblies; such as, for example, a straight pin, a clamp, or a hook. This type of tag, as it is made of a thin, flexible piece of polymer, is prone to bending or flexing. During normal use, these tags have a tendency to become crimped, thereby fatiguing the polymer and, in certain sections, causing the identification tag to become opaque, thus reducing the visibility of the indicia panel carried thereby. In addition, the flexing or bending of the thin plastic of these identification tags causes the tag to appear flimsy and unsubstantial and is prone to tearing, and thus produces an unattractive, unprofessional appearance. Furthermore, with tags formed as a flattened tube that opens to the two lateral sides, the indicia-carrying panels have a tendency to slide through the tag, thereby requiring the wearer to reinsert the indicia-carrying panel. Also, identification tags are normally intended for a single use, and when the engagement for which they are worn is concluded, they are disposed of, thereby increasing both cost and waste.

Consequently, there is a need for a reusable, rigid identification tag configured to securely hold the indicia-carrying panel therein, which is cost effective to manufacture and retains its professional appearance through repeated use.

### SUMMARY OF THE INVENTION

According to one aspect of the invention, the identification tag includes a first rigid panel having a substantially transparent zone thereon and a second rigid panel joined to the first rigid panel at a lower region thereof by a resilient hinge. An indicia-carrying panel is dimensioned to be removably inserted between the first and second panel, and includes an indicia zone thereon adapted to carry an indicia. The indicia zone is in general registration with the substantially transparent zone of the first rigid panel when the indicia-carrying panel is disposed between the first and second panels, while a tag-mounting element is coupled to at least one of the rigid panels. The rigid panels of the identification tag assure that the indicia-carrying panel remains clearly visible and permits the identification tag to be reused.

According to another aspect of the invention, a name tag holder includes front and back holder panels joined at the lower region thereof by a flexible, resilient living hinge. The front holder panel includes a transparent region thereon, while both the front and back holder panels are substantially rigid and form an indicia panel seat therebetween. An indicia-carrying panel is shaped to be removably inserted between the front and back holder panels and within the indicia panel seat, while a tag-mounting element is coupled to at least one of the front and back holder panels. Joining a front and back holder panel by a flexible resilient living hinge effectively secures the indicia-carrying panel therebetween.

According to yet another aspect of the invention, a name tag holder includes a polymeric holder member bent into a generally U cross-sectional shape and has a rigid, substantially transparent front panel and a rigid back panel joined by a flexible, resilient lower joint, with the lateral sides and top of the front panel being unconnected with the lateral sides and top of the back panel. One of the front and back panels is taller than the other, while a neckband is coupled to an upper region of the taller panel. An indicia panel is clamped between the front and back panels and adapted to bear indicia thereon. A rigid, U-shaped name tag holder formed of a polymeric material reduces manufacturing costs, while the flexible, resilient lower joint securely holds an indicia panel therebetween.

The preferred embodiment provides an identification tag that is substantial in appearance and feel so as to provide a professional and permanent appearance, yet maintain low cost in materials and manufacture. These and other objects, advantages, purposes, and features of the invention will become apparent upon review of the following specification in conjunction with the drawings.

### BRIEF DESCRIPTION OF THE DRAWINGS

FIG. 1 is a perspective view of an identification tag according to the present invention, illustrated worn by an individual;

FIG. 2 is a front elevational view of the identification tag of FIG. 1, shown without a neckband;

FIG. 3 is a front elevational view of the identification tag of FIGS. 1 and 2, shown with an alternative preferred adjustable neckband;

FIG. 4 is a side elevational view of the identification tag holder of FIGS. 1-3, illustrated in the closed position;

FIG. 5 is an exploded side view of the identification tag removed from the identification tag holder of FIGS. 1-4, illustrated in the open position; and

FIG. 6 is the same view as FIG. 5, according to an alternative preferred embodiment.

### DETAILED DESCRIPTION OF THE PREFERRED EMBODIMENTS

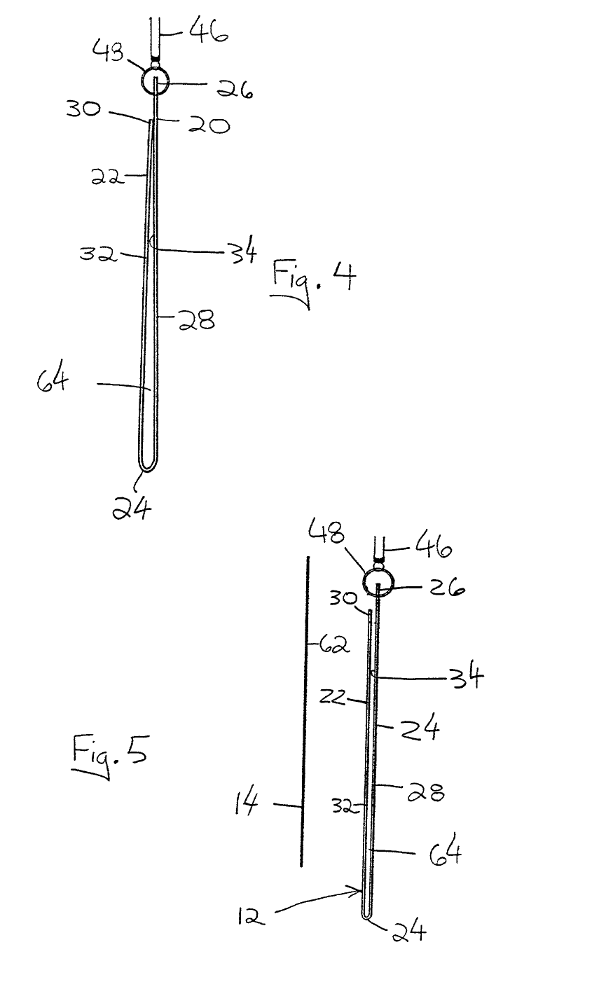

Referring now to the drawings, an identification or name tag 10 is shown in a preferred form and having identification holder element 12 (FIGS. 5, 6) and an indicia carrying panel 14 that is seated in holder element 12. Preferably, identification holder element 12 includes a front panel 20 and a rear panel 22 joined by a flexible resilient joint 24. Holder element 12 has a generally U-shaped cross-section and is formed of a rigid, substantially transparent polymeric material. Preferably, front panel 20, rear panel 22, and joint 24 are monolithically formed, while joint 24 is a living hinge. Front panel 20 includes a top edge 26 and lateral sides 28, while rear panel 22 includes a top edge 30 and lateral sides 32. When used, indicia carrying panel 14 is seated in holder element 12 and is clamped in place by the spring force of joint 24. Name tag 10 provides a permanent and aesthetic professional appearance that may be customized by printing on indicia carrying panel 14.

Front panel 20 preferably is taller or has a greater height as measured between joint 24 and top edge 26 than the height of rear panel 22. Both panels are preferably linear and are nonparallel with respect to one another. That is, as seen most clearly in FIG. 4, rear panel 22 is angled towards interior surface 34 of front panel 20 so that edge 30 is in abutting contact with interior surface 34. Panels 20 and 22 define therebetween an indicia panel seat 64. Additionally, front panel 20 and rear panel 22 are unjoined along the respective lateral sides and top edges.

Front panel 20 is formed with a substantially transparent zone 36 that provides for display of indicia carrying panel 14 behind zone 36. Substantially transparent zone 36 may extend across the entirety of front panel 20 between sides 28 and top edge 26, and to joint 24. Thus formed, the entirety of indicia carrying panel 14 may be viewed while in holder element 12. Alternatively, transparent zone 36 may be a discrete section of front panel 20 and bordered by an opaque, colored or printed region. In such an embodiment, the indicia carried on indicia carrying panel 14 may be aesthetically framed or highlighted. In addition, front panel 20 may have raised thereon or inscribed therein information-carrying indicia. For example, the name of a corporation or organization may be inscribed on front panel 20 and adjacent to transparent zone 36. With such embellishment, for example, a corporate name may be permanently affixed to holder element 12, and reused with different personal names or indicia on indicia carrying panel 14 which are discarded. Rear panel 22 may be opaque, substantially transparent, or some combination thereof.

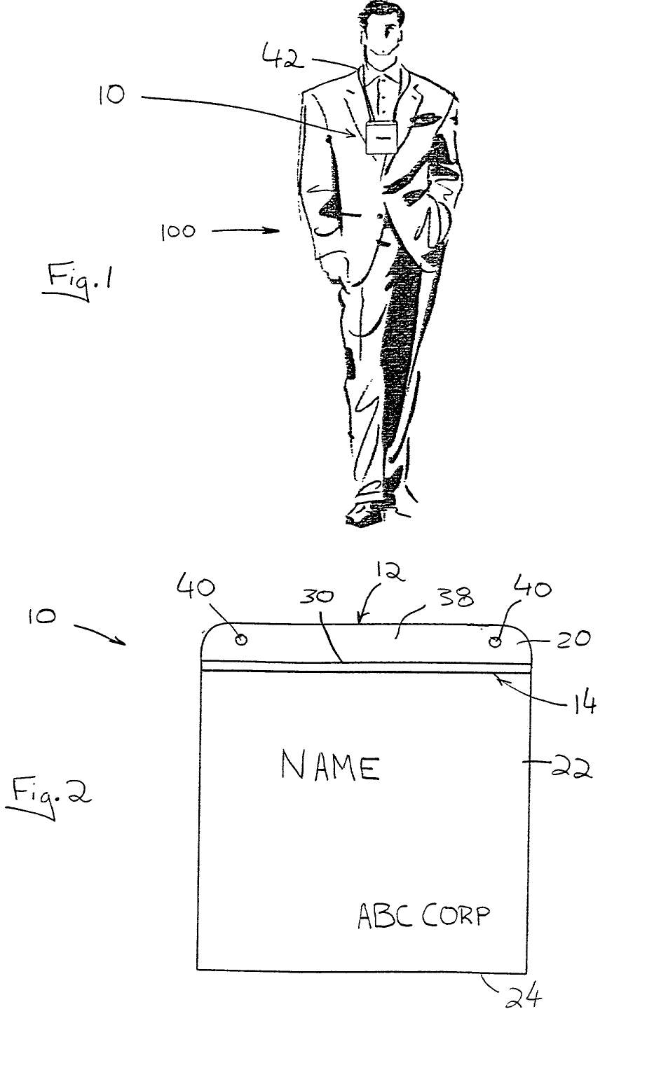

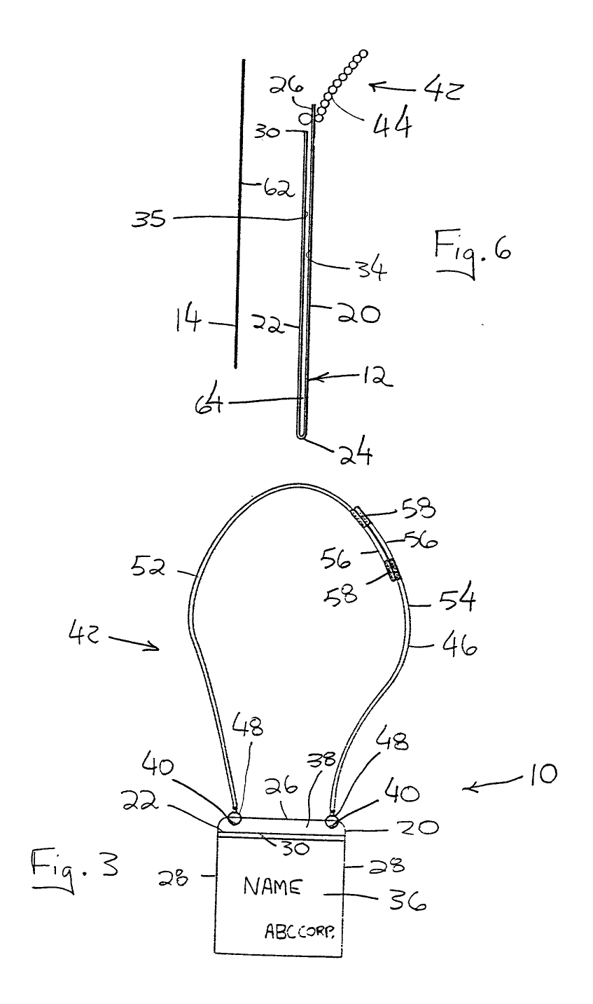

Top region 38 of front panel 20 includes a pair of spaced apertures 40 formed therethrough and positioned above top edge 30 of rear panel 22. Apertures 40 are dimensioned to receive a tag-mounting element 42. Preferably, tag-mounting element 42, as shown in FIG. 1, is a neckband, which enables tag 10 to be hung around the neck of an individual 100 (FIG. 1). Tag-mounting element 42 may be a conventional ball-and-chain assembly 44 as illustrated in FIG. 6. Alternatively, as shown in FIGS. 3 through 5, tag-mounting element 42 may be a polymeric lanyard 46 attached to an O-ring attachment assembly 48 which is fitted through apertures 40. Preferably, tag-mounting element 42 is a single piece of material. As shown in FIG. 3, however, in an alternative preferred embodiment, tag-mounting element 42 includes two sections 52 and 54 joined together at ends 56 by a set of securing members; such as, for example, a set of hook-and-loop fasteners 58.

Positioned between interior surface 34 of front panel 20, and interior surface of rear panel 22, and with indicia panel seat 64, is indicia-carrying panel 14. Indicia-carrying panel 14 may have imprinted thereon any information required by the particular application. Indicia-carrying panel 14 includes an indicia-carrying zone 62 which, when positioned between front panel 20 and rear panel 22, is in substantial registry with transparent zone 36 of front panel 20. Panel 14 may include decorative printing or shading in addition to the identification indicia carried thereon, which may be viewed through front panel 20 or which, in embodiments having a colored or printed region on front panel 20, cooperate with coloring or printing on front panel 20.

To insert indicia-carrying panel 14 between front and rear panels 20 and 22, a slight force is applied to rear panel 22, moving rear panel 22 away from interior surface 34 of front panel 20. Movement of rear panel 22 in a direction away from front panel 20 defines an open position, as shown in FIGS. 5 and 6. Once holder element 12 is in the open position, indicia-carrying panel 14 is positioned within indicia panel seat 64. Thereafter, joint 24 pivots rear panel 22 towards front panel 20 so that top edge 30 contacts indicia-carrying panel 14 and thereby provides a clamping force which clamps or secures indicia-carrying panel 14 between front panel 20 and rear panel 22. Tag mounting element 42 is then strung around the neck of the user such that front panel 20 is positioned farthest from the body of the individual 100. Although in most preferred form taller front panel 20 is positioned in front of shorter rear panel 22, alternatively, taller front panel 20 may be worn rearward of shorter rear panel 22. Further, although tag mounting element 42 is preferably a neckband or lanyard, alternatively, tag mounting element 42 may be a pin, clip or other tag mounting element.

In most preferred form, holder element 12 is a single piece of substantially transparent Plexiglas™ material about 1/16th inch thick and bent into the generally U-shaped cross-section with a spring clamping joint at the lowermost end. Most preferably, rear panel 22 is about 3 inches square and front panel 20 is about 3.375 inches high. Most preferably, indicia carrying panel 14 is stiff paper stock printed by conventional printing methods.

The foregoing description is of the preferred embodiments only. Changes and modifications in the specifically described embodiments can be carried out without departing from the principles of the invention. Therefore, the invention is intended to be limited only by the scope of the appended claims, as interpreted according to the principles of patent law, including the doctrine of equivalents.

The embodiments of the invention in which an exclusive property or privilege is claimed are defined as follows:

1. An identification tag comprising:
a first rigid panel having a substantially transparent zone thereon;
a second rigid panel joined to said first rigid panel at a lower region thereof by a resilient hinge;
an indicia-carrying panel dimensioned to be removably inserted between said first rigid panel and said second rigid panel, said indicia-carrying panel including an indicia zone thereon adapted to carry an indicia, said indicia zone disposed to be positioned in substantial registration with said substantially transparent zone of said first rigid panel when said indicia-carrying panel is disposed between said rigid panels; and
a tag-mounting element coupled to at least one of said rigid panels.

2. The identification tag of claim 1, wherein said hinge is a flexible, resilient joint between said first rigid panel and said second rigid panel.

3. The identification tag of claim 2, wherein said first rigid panel, said second rigid panel, and said hinge are monolithic and said hinge is a living hinge.

4. The identification tag of claim 1, wherein each rigid panel of said first rigid panel and said second rigid panel has two lateral sides and a top edge, wherein said top edges and corresponding lateral sides are substantially unjoined.

5. The identification tag of claim 4, wherein said first rigid panel has a greater height than said second rigid panel.

6. The identification tag of claim 5, wherein said tag-mounting element is a neckband coupled to an upper portion of said first rigid panel and disposed above said second rigid panel.

7. A name tag holder comprising:
a front and a back holder panel joined at the lower region thereof by a flexible, resilient living hinge;
said front holder panel having a transparent region thereon;
said front and back holder panels being substantially rigid and forming an indicia panel seat therebetween;
an indicia carrying panel shaped to be removably inserted between said holder panels in said indicia panel seat; and
a tag-mounting element coupled to at least one of said front and said back holder panels.

8. The name tag holder of claim 7, wherein said front and said back holder panel each have two lateral sides and a top edge, wherein said top edges and corresponding lateral sides are substantially unjoined.

9. The name tag holder of claim 7, wherein said tag-mounting element is a neckband.

10. The name tag holder of claim 9, wherein said neckband is attached to said front holder panel.

11. The name tag holder of claim 7, wherein said back holder panel is transparent.

12. A name tag holder comprising:
a polymeric holder member bent into a generally “U” cross-sectional shape and having a rigid, substantially transparent front panel, and a rigid back panel joined by a flexible, resilient lower joint, wherein the lateral sides and top of said front panel are unconnected with the lateral sides and top of said back panel;
one of said front and back panels being taller than the other of said front and back panels;
a neckband coupled to an upper region of said taller panel; and
an indicia panel clamped between said front and back panels and adapted to bear an indicia thereon.

13. The name tag holder of claim 12, wherein said transparent front panel is taller than said back panel.

14. The name tag holder of claim 12, wherein said neckband comprises two sections, each section of said two sections having an end, wherein said ends are configured to be secured one to another.
